(19) United States
(12) Patent Application Publication
(10) Pub. No.: US 2023/0115720 A1
(43) Pub. Date: Apr. 13, 2023

(54) Avoiding Intensity Sources in Pathfinding for Software Agents in a Digital Twin

(71) Applicants: Christopher A. Guryan, Vienna, VA (US); Aaron Robert Kraft, Vienna, VA (US); Bradford Sims Robnett, Vienna, VA (US); Joshua David Jewett, Vienna, VA (US); Allan Phillips Frankel, Vienna, VA (US)

(72) Inventors: Christopher A. Guryan, Vienna, VA (US); Aaron Robert Kraft, Vienna, VA (US); Bradford Sims Robnett, Vienna, VA (US); Joshua David Jewett, Vienna, VA (US); Allan Phillips Frankel, Vienna, VA (US)

(21) Appl. No.: 17/962,653

(22) Filed: Oct. 10, 2022

Related U.S. Application Data
(60) Provisional application No. 63/253,649, filed on Oct. 8, 2021.

(51) Int. Cl. G06T 19/00; G06T 17/20

(52) U.S. Cl. CPC G06T 19/003; G06T 17/20

(57) ABSTRACT

The present disclosure provides an automated pathfinding system and method designed or adapted to minimize or eliminate exposure to detection, firepower, radiation or use of cover and concealment when mapping in a digital twin environment.

### CROSS REFERENCE TO RELATED APPLICATIONS

This application claims priority to, and the benefit of, pending U.S. Provisional Application Ser. No. 63/253,649 filed Oct. 8, 2021.

### FIELD OF THE DISCLOSURE

The present disclosure pertains to the field automated pathfinding within a digital twin.

### BACKGROUND

The use of pathfinding solutions is common in some digital environments, such as video games or vehicle navigation. However, these prior art solutions plan paths for game characters that minimize traversal time or travel distance. Similarly, mapping services from Google®, Apple®, Microsoft®, public safety dispatch applications and others represent road networks as a graph and find routes for users that minimize the time to travel between a start point and a destination, based on road type, traffic conditions, and so on. None of the prior art solutions are designed or adapted to minimize or eliminate exposure to detection, firepower, radiation or use of cover and concealment when mapping. The current application provides such solutions, systems and methods that are needed in the art.

### BRIEF DESCRIPTION OF DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. This application contains at least two (2) drawings executed in color. The invention will be described and explained with additional specificity and detail through the use of the accompanying drawings in which:

FIG. 1 shows one embodiment of a navigational mesh generated from a digital twin.

FIG. 2 shows one embodiment of determining the angular dependence of detection.

### DETAILED DESCRIPTION

To operate autonomously in a simulated world, software agents need to plan activities based on the state of that world, the agents' perception of the state, and on their internal state. Once these activities, perceptions and internal states are determined, and interactions components inside of the world are determined or modeled, simulations concerning the agents' activities can run without human interaction. This enables large numbers of simulations to be executed so that rare events can have a chance to occur and thus studied or planned for, and statistical summaries of the results can be developed. It allows software agents to re-plan their activities based on new perceptions of the simulated world and, if appropriate, take into account the rare event(s). In addition, a sufficiently accurate model of a real location, also known as a digital twin, enables autonomous operation of robots in the real world.

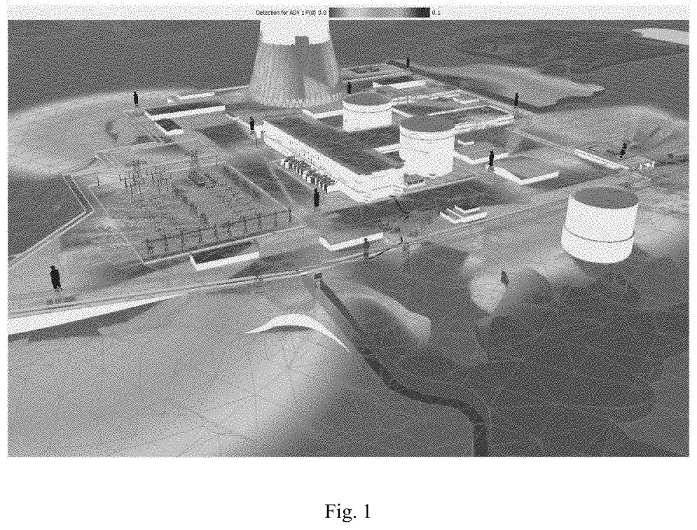

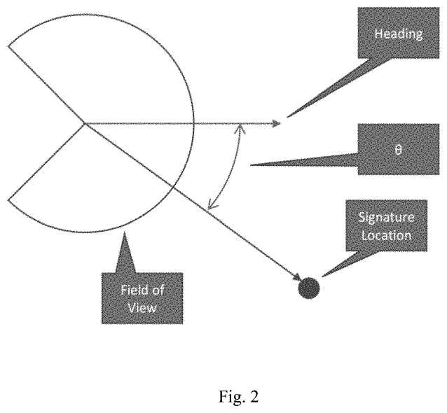

Now referring to FIGS. 1 and 2, in one embodiment, a digital twin is created of the real-world environment or site. The digital twin is a 3D model of the site of interest. The digital twin may feature detailed representations buildings, fences (or other barriers), roads, terrain, gates, doors, sensors, security, and communication systems, etc. present at the site. The digital twin can be created using any number of commercially available software packages including Autodesk®, ESRI, and Microstation. The digital twin provides real-world data that can be incorporated by the system and method provided herein.

Movement through a digital twin can be modeled by approximating the 3D geometry with a navigation mesh, representing that mesh as a mathematical graph, and solving the graph in a way that minimizes the “cost” of traversing the graph. Algorithms finding the minimum cost, such as A*, are well-known and heavily used in the gaining and navigation industries. Typically, the property minimized is travel time: online mapping programs, for example, can minimize the travel time from a start to a destination by representing a road network as a graph.

However, in certain situations the importance of travel time is minimized or eliminated altogether. For example, when modeling an adversary penetrating a secure site, a guard force responding to an adversary incursion, or a worker moving through a radiation-contaminated site, minimizing travel time may not represent the most effective way for software agents to move. For example, the fastest route to a destination inside a heavily guarded site may cause an agent to travel through the field of view of a sensor, or within range of a gun emplacement. In avoiding radiation exposure, the ALARA (As Low As Reasonably Achievable) principle stresses the importance of maintaining distance and using shielding in addition to minimizing exposure time.

In order to determine the desired pathfinding information, the present disclosure weights the edges of a graph by the exposure of an agent traversing the graph to sources that may be scattered throughout the digital twin. The contribution to the edge weight of each source can be modified by the distance between the source and the edge, by the orientation of the source, and also by any obstructions on the line of sight between the source and edge. In addition, exposure to detection and firepower can be treated as probabilities: minimizing exposure to detection and firepower is equivalent to minimizing the probability of detection or neutralization. The following types of exposure can be modeled:
Detection sources, such as cameras, radar, and human sensing capabilities like eyes and ears
Firepower sources, like fixed gun emplacements or small arms carried by guards on patrol routes
Radiation sources, such as nuclear waste containment areas

When solving the graph, edge weights are calculated by taking into account the intensity of all sources as described below. The A* algorithm has been implemented to find the lowest cost path through the weighted graph.

Minimizing edge weights based on time to cross the edge, as is typically done in navigation and gaining applications, can result in plans for agents that are inappropriate in a security application. For example, an agent could be exposed unnecessarily to detection or to weapons fire from opposing forces. The present disclosure accounts for exposure to detection and weapons fire in a consistent way.

FIGS. 1 and 2 provide one embodiment of the system and method disclosed herein. In the embodiment shown therein, the agent (shown in red, not to scale), follows a path (dark blue) which minimizes the probability of detection from ten guard agents shown in blue. In order for this path to be found, the following parameters are defined:
One or more signatures for the pathfinding agent. A signature determines how well a detector can sense the agent. An agent may possess multiple signatures so that items possessed by the agent (e.g., equipment such as tools, weapons, or vehicles) can contribute to detection.
A terrain on which the agents may move. The navigation mesh is created in such a way that each triangle contains a single terrain.
Opacity values for any obstructions to line of sight between a detector and a detected agent. The opacity is 0 if the obstruction is completely opaque to the detector, and 1 if it is completely transparent. The total opacity o of an obstruction is defined by a per-unit of distance measure of opacity, denoted γ, such that, for an obstruction with thickness D, o(D)=e^{-γ·D}. A line between two points can pass through any number of obstructions, each with a different thickness, and each potentially having its own opacity. Denote by oᵢ(a, b) the i^{th} obstruction between a and b, γ(oᵢ(a, b)) the opacity of the i^{th} obstruction, and D(oᵢ(a, b)) its thickness. Then the total opacity from a to b is o(a, b)=e^{-Σγ(o}^{ᵢ}^{(a, b))·D(o}^{ᵢ}^{(a, b))}.
One or more detectors. Detectors may be owned by agents (e.g., eyes and ears) or may represent cameras, radars, etc. Each detector is additionally defined by
A location represented by a 3D point g_{d}. The subscript indicates that there may be many detectors.
A heading, specified as a unit vector ĥ_{d}.
A detection rate r_{ds}. There is one detection rate for each combination of detector (d), signature owned by the detected agent (s), and terrain. Having a distinct detection rate per terrain allows for a lower detection rate in areas that may contain some cover (e.g., tall grass) than in areas with no cover (e.g., a runway) without detailed modeling of such cover. The detection rate also depends on the distance between the detector and the detected agent, and the angle between the detector's heading and the signature location (denoted θ).
A detection range, which is the greatest distance at which the detector is effective for a given signature and terrain.
A platform, which is a property of the detected agent that determines its speed over each terrain type in the model.

The present disclosure systems and methods minimize exposure to detection, firepower, radiation, or other environmental concerns that can be described by a rate of exposure. That exposure rate may depend on the range and angle from a source to an agent, and by intervening obstructions. An agent using a costing function that minimizes exposure can find plans through a facility that take advantage of gaps in detection or firepower coverage caused by improper placement of these exposure sources. Additionally, the costing functions for different exposure types can be combined so that paths attempt to avoid multiple types of exposure.

The probability of detection as the agent crosses an edge eᵢⱼ that connects vertex i to vertex j needs to be calculated. The agent starts at vertex i at time tᵢ and arrives at vertex j at time tⱼ. The agent's position is denoted as a function of time as a three-dimensional vector x(t). Assuming that every graph edge is a straight line, and is restricted to a single terrain type, and that the agent moves at a constant speed, the agent's position can be determined as it moves from vertex i to vertex j as

$$x ( t ) = {x}_{i} + {v}_{ij} ( t - {t}_{i} ) \frac{{x}_{j} - {x}_{i}}{\vert {x}_{j} - {x}_{i} \vert}$$

where xᵢ is the location of vertex i, xⱼ is the location of vertex j, and vᵢⱼ is the agent's speed over the terrain on edge eᵢⱼ. It is assumed that the position d of the detector is fixed. With these items defined, the effective detection rate of a single signature by a single detector that is incurred as the signature's owner crosses the edge of the graph can be calculated. The effective detection rate for a detector at point d is

$${r}_{ijds} ( {g}_{d} ) = \frac{1}{{t}_{j} - {t}_{i}} {\int }_{{t}_{i}}^{{t}_{j}} {r}_{ds} {R}_{d} ( \vert x ( t ) - {g}_{d} \vert ) {F}_{d} ( ( x ( t ) - {g}_{d} ) \cdot \hat{h} ) {o}_{d} ( x ( t ) , {g}_{d} ) dt$$

where r_{ds} a constant detection rate of detector d against signature s, R_{d} is the dependence of detection on range for detector d, F_{d} the dependence on angle of detector d, and o the total opacity for detector d, located at g_{d}, to a point on the edge.

In general, this quantity cannot be calculated in a closed form, but the integral can be approximated. The probability of detecting signature s crossing edge eᵢⱼ due to the detector at g_{d} is then

P_{ijds}(g_{d})=1−e^{-r}^{_{ijds}}^{(g}^{_{d}}^{)(t}^{ⱼ}^{-t}^{ᵢ}⁾.

There can be many detectors contributing to the probability of detection across a single node, each with its own location, heading, range function, angular dependence, and opacity value. The total probability of detection is the mathematical OR of detection by any single detector, so for a set of detectors {g}:

$${P}_{ijs} ( \{ g \} ) = 1 - {\prod }_{d} ( 1 - {P}_{ijds} ( {g}_{d} ) ) = 1 - {e}^{- {\sum }_{d} {r}_{ijds} ( {g}_{d} ) ( {t}_{j} - {t}_{i} )}$$

In addition, as previously stated the detected agent may carry any number of signatures. The probability for each signature is OR'ed together similarly so that

Pᵢⱼ({g})=1−e^{-Σ}^{ₛ}^{Σ}^{_{d}}^{r}^{_{ijds}}^{(g}^{_{d}}^{)(t}^{ⱼ}^{-t}^{ᵢ}⁾

The probability of detection along a sequence of edges is the OR of the probability of each edge. In order to work with standard graph algorithms, the edge weights must be additive. This can be done by taking the natural logarithm of the complement of the detection probability.

$${w}_{ij} ( \{ g \} ) = - ln ( 1 - {P}_{ij} ( \{ g \} ) ) = {\sum }_{s} {\sum }_{d} {r}_{ijds} ( {g}_{d} ) ( {t}_{j} - {t}_{i} )$$

Since the probability of detection is a value between 0 and 1, the value of wᵢⱼ will be between 0 and positive infinity. Standard graph-solving algorithms can be used to find a path through the graph that minimizes the cost as defined above. For a path consisting of vertices 1, 2, . . . n, the total cost is

$$W = {\sum }_{i = 1}^{n - 1} {w}_{i ( i + 1 )} ( \{ g \} ) = {\sum }_{i = 1}^{n - 1} {\sum }_{s} {\sum }_{d} {r}_{ijds} ( {g}_{d} ) ( {t}_{i + 1} - {t}_{i} )$$

The total probability of detection along a path can be recovered from the total weight:

P=1−e^{-Σ}^{ᵢ₌₁}^{^{n−1}}^{Σ}^{ₛ}^{Σ}^{_{d}}^{r}^{_{ijds}}^{(g}^{_{d}}^{)(t}^{ᵢ₊₁}^{-t}^{ᵢ}⁾

Since the logarithm function is monotonically increasing, minimizing the weight minimizes the detection probability.

The preceding discussion assumes that detectors are at known locations g_{d}. Detectors whose exact locations are known only approximately can be modeled by describing what is known about the location in the form of a probability density function. This function represents where the pathing agent believes the detector to be. For example, surveillance of a site might reveal that guards (who possess detection capabilities) patrol in known patterns, but an adversary attempting to infiltrate the site may not know where the guards are at a specific point in time. In that case we can represent each guard's location as being uniformly distributed over its patrol route. More generally, if a detector's location distribution is ρ(d), then

$${r}_{ijds} = \frac{1}{V ( {t}_{j} - {t}_{i} )} {\int }_{V} ρ ( d ) {\int }_{{t}_{i}}^{{t}_{j}} {r}_{ds} {R}_{d} ( \vert x ( t ) - {g}_{d} \vert ) {F}_{d} ( ( x ( t ) - {g}_{d} ) \cdot \hat{h} ) {o}_{d} ( x ( t ) , {g}_{d} ) dt dV$$

where V is the volume of integration.

Effective detection rates for approximately known detectors can be added to the total detection rate in the same way as those for detectors at a known location. With the edge weight calculations in place, a path for an agent with some set of signatures can be found through a digital twin containing detectors at both known and approximate locations using algorithms such as A*. Importantly, if an agent is able to detect a previously approximately known or unknown detector, or the agent is given updated information about the location of a detector through a modeled communications channel, then the agent can re-weight the graph with the updated information and find a new path. This allows software agents to adapt their plans as the simulation evolves.

Minimizing the probability of being neutralized by one or more stationary or moving firepower sources proceeds in the same way as the detection discussion, with the following alterations:
Rather than defining signatures for the pathfinding agent, that agent has armor that determines the lethality of different weapon types for the agent. An agent may possess multiple armors so that items that could protect the owner (such as a vehicle) are accounted for.
Rather than defining detectors, agents may possess one or more weapons. Like detectors, weapons will have a location and heading (shared with its owning agent). A kill rate, defined as the weapon's fire rate multiplied by its probability of neutralizing an agent with a specific armor type, replaces the detection rate. The kill rate depends on the range from the weapon to the armor.
The detection discussion assumes that an agent can use multiple detectors simultaneously. This means that a pathing agent must plan to avoid all of an opponent's sensors (e.g., both eyes and ears) and so all sensors owned by the opponent contribute to the edge weight. However, it is possibly more realistic to assume that an agent can use only a single weapon at a time. In that case, the pathing agent would plan to avoid an opponent's most effective weapon at a given range, and only that weapon would contribute to the edge weight. Contributions to the firepower edge weight from multiple agents would be summed as with the detection example.

Minimizing exposure to radiation proceeds closely along the same lines as detection. In most cases we would be interested only in a single signature s, and the rate r_{ds} represents the exposure of the s^{th} signature to the d^{th} radiation source.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise.

Although particular embodiments of the present disclosure have been described, it is not intended that such references be construed as limitations upon the scope of this disclosure except as set forth in the claims.

We claim:

1. A method for pathfinding comprising:
a. defining one or signatures for a pathfinding agent;
b. creating a navigational mesh;
c. defining opacity values for any obstructions to line of sight between a detector and a detected agent; and
d. defining one or more detector.
